(19) United States
(12) Patent Application Publication
(10) Pub. No.: US 2025/0047150 A1
(43) Pub. Date: Feb. 6, 2025

(54) STATOR FOR AN ELECTRIC MOTOR AND ELECTRIC MOTOR HAVING THE STATOR

(71) Applicant: Brose Fahrzeugteile SE & Co. Kommanditgesellschaft, Würzburg, Würzburg (DE)

(72) Inventors: Alexander VOLKAMER, Oberscheinfeld (DE); Oliver HAUPT, Würzburg (DE)

(21) Appl. No.: 18/921,542

(22) Filed: Oct. 21, 2024

Related U.S. Application Data
(63) Continuation of application No. PCT/EP2023/060006, filed on Apr. 18, 2023.

(30) Foreign Application Priority Data
Apr. 25, 2022 (DE) 10 2022 203 978.5

(51) Int. Cl. H02K 1/18; H02K 3/32; H02K 3/50

(52) U.S. Cl. CPC H02K 1/18; H02K 3/32; H02K 3/50; H02K 2213/03

(57) ABSTRACT

A stator is provided for an electric motor. The stator includes a stator main body with radially inwardly directed stator teeth with a stator winding disposed thereon, an insulating ring disposed on an end face of the stator main body, and a contact adapter, which can be placed onto the insulating ring and which has contact elements for the connection contacting of winding ends of the stator winding. The contact adapter has a joining opening and the insulating ring has a tab pair which corresponds with the joining opening and which has a centering tab and a parallel spring tab, which, when the contact adapter is joined, is received together with the centering tab into the joining opening of the contact adapter.

### CROSS-REFERENCE TO RELATED APPLICATION

This application is a continuation, under 35 U.S.C. § 120, of copending International Patent Application PCT/EP2023/060006, filed Apr. 18, 2023, which designated the United States; this application also claims the priority, under 35 U.S.C. § 119, of German Patent Application DE 10 2022 203 978.5, filed Apr. 25, 2022; the prior applications are herewith incorporated by reference in their entirety.

### FIELD AND BACKGROUND OF THE INVENTION

The invention relates to a stator for an electric motor. The stator contains a stator main body with a stator winding arranged on radially inwardly directed stator teeth, an insulating ring arranged on an end face of the stator main body and a contact adapter with plug-in pockets for contact elements for the connection contacting of winding ends of the stator winding. The invention also relates to an electric motor containing such a stator.

A, in particular, brushless electric motor as an electric three-phase machine has a stator with a stator main body, for example configured as a stator laminated core, with a number of stator teeth, for example arranged in a star shape, which carry an electric rotary field winding in the form of individual stator coils, which in turn are wound from an insulating wire. The coils are assigned to individual strands or phases with their coil ends and are interconnected in a predetermined manner via contact elements.

In the case of a brushless electric motor as a three-phase machine, the stator assembly has three phases and thus at least three phase conductors or phase windings, each of which is supplied with electrical current out of phase in order to generate a magnetic rotary field in which a rotor, usually equipped with permanent magnets, rotates about an axis of rotation, which also represents the central (stator) axis. The phase ends of the phase windings are fed to the motor electronics to control the electric motor. The coils of the rotary field winding are interconnected with each other or by means of the phase ends in a certain way. The type of interconnection is determined by the winding scheme of the rotary field winding, wherein a circuit or a delta connection of the phase windings is common as the winding scheme.

An insulating ring is placed on an end face of the stator main body. An insulating ring can also be arranged on the axially opposite end face of the stator main body. The insulating rings have, for example, cap-like, insulating coil or winding bodies corresponding to the number of stator teeth, which surround the respective stator tooth, in particular leaving the tooth surface on the pole shoe side exposed. The coil bodies have, for example, groove-like recesses or wire grooves for guiding the winding wires and/or side walls to prevent (radial) loosening of the wound coil from the stator tooth. For example, only a specific axial portion of the respective winding body can be formed on the respective insulating ring, which portion is complementary to the corresponding portion of the other insulating ring to form the winding body.

Typically, at least one of the insulating rings contains a so-called termination, which protrudes axially from the stator main body as a segmented circular ring-like wall. The termination allows the winding or coil wires to be guided circumferentially behind the stator teeth from stator tooth to stator tooth during a winding process so that the winding wires do not collide with the winding tool.

The wire or phase ends can be contacted during the interconnection of the rotary field winding using insulation displacement contacts as contact elements. These can be accommodated with simultaneous insulation displacement contacting in plug-in pockets of a ring-shaped contact adapter, which is placed on the insulating ring carrying the winding or coil wires and overlaps it, in particular on three sides. The insulation displacement contacts can be used to make contact with, for example, busbar-type connection contacts as phase connections and make them electrically conductive with motor electronics. The problem here is often insufficient centering or alignment of the contact adapter. Centering or alignment of the contact adapter is particularly important with regard to the most precise possible positioning of the connection contacts for their contacting with the phase connections. Centering pins on the insulating ring would be conceivable in order to align the contact adapter as reliably as possible when joining with the insulating ring.

However, it is undesirably complex to produce the required position tolerance of such centering pins, wherein tolerances of the individual centering pins can lead to undesired play of the contact adapter at the (mechanical) interface with the insulating ring and thus to a higher position tolerance of the connection contacts.

### SUMMARY OF THE INVENTION

The invention addresses the problem of specifying a particularly suitable stator for an electric motor. In particular, reliable centering of the contact adapter and/or compensation of existing tolerances should be made possible at the interface of a contact adapter with an end-face insulating ring of the stator. Furthermore, an electric motor comprising such a stator is specified.

With regard to the stator, the stated problem is solved with the features of the independent stator claim and, with regard to the electric motor, with the features of the independent electric motor claim, in accordance with the invention. Advantageous embodiments and developments are the subject of the dependent claims.

The stator provided for an electric motor, in particular as an electric drive of an assembly or an adjusting element of a motor vehicle, has a stator main body and an insulating ring arranged on an end face of the stator main body or mounted on an end face of the stator main body, as well as a contact adapter with a number of axially oriented plug-in pockets for contact elements which can be placed on or mounted on the insulating ring. The stator main body has a number of stator teeth which are directed radially inwards towards a central axis, which in turn represents the axis of rotation of a rotor and thus of the electric motor. Coils of a stator or rotary field winding are arranged on the stator teeth. The contact elements, which are suitably designed as insulation displacement contacts, are provided and set up for connecting winding ends of the stator winding.

The contact adapter has at least one, preferably only one, joining opening, with which an axially oriented pair of tabs of the insulating ring preferably corresponds and/or aligns. The joining opening runs tangentially or azimuthally, i.e., in the circumferential direction of the contact adapter of the stator, also referred to below as the stator assembly, or its stator main body, and is locally delimited. The joining opening is suitably arranged in the region of a boundary or transition edge between an annular base plate or disk of the contact adapter and a preferably circumferential edge web, which is formed on the base plate and which at least partially covers the insulating ring axially on the circumferential side. The azimuthal extent or circular arc length of the joining opening is, for example, in the order of 1/30 of the (circle) circumference of the contact adapter.

The insulating ring has an axial centering tab corresponding to the joining opening of the contact adapter, in particular aligned with the joining opening, and an axial spring tab parallel to it, which is received in the joining opening of the contact adapter together with the centering tab in the joined state of the contact adapter or engages through it. Preferably, the tab width of the centering tab, also referred to below as the centering pin, is greater in the circumferential direction of the insulating ring, in particular by a factor of 2 to 3, than the tab width of the spring tab, also referred to below as the spring pin. The centering tab is suitably particularly stable due to its tab width, especially in comparison to the spring tab.

In an advantageous embodiment, the centering tab of the insulating ring has an axially extending positioning edge and an inlet edge that adjoins it in the axial direction and is set at an angle of inclination to the spring tab. The angle of inclination relative to the axially extending positioning edge is typically between 30° and 60°, preferably (45±5).

Preferably, only the positioning edge of the centering tab or centering pin is precisely toleranced on the insulating ring, wherein the contact adapter is suitably aligned with this positioning edge when it is placed or pressed onto the insulating ring. For practical purposes, the contact adapter has a number of axially extending joining tabs which, in the joined state, engage with the insulating ring or, in the course of pressing the contact adapter onto the insulating ring, with joining elements arranged on the latter, in particular radially oriented joining elements.

In an advantageous embodiment, the spring tab (the spring pin) of the insulating ring has an axially extending joining edge and a sliding edge adjoining it in the axial direction and inclined at an angle to the centering tab.

Suitably, the angle of attack relative to the axially extending joining edge is between 50° and 70°, preferably (60±5).

A free space is expediently formed between the centering tab and the spring tab of the insulating ring, into which free space the spring tab springs or can spring when inserted into the joining opening of the contact adapter. The distance between the centering tab and the spring tab of the insulating ring is particularly advantageous as it is smaller than the tab width of the centering tab. Additionally or alternatively, the distance between the centering tab and the spring tab of the insulating ring is greater than or equal to the tab width of the spring tab. Additionally or alternatively, the axial tab length of the centering tab is at least slightly greater than the axial tab length of the spring tab of the insulating ring.

The spring tab of the insulating ring provides the necessary tolerance compensation on the one hand and eliminates all play from the interface between the contact adapter and the insulating ring on the other. As a result, the position tolerance of the connection contacts can be significantly reduced. In addition, component costs are reduced, and the position tolerance of the connection contacts is improved. The centering tab of the insulating ring is particularly advantageous in centering the contact adapter in its target position in that, or while, the centering tab on the insulating ring side penetrates into the joining opening on the contact adapter side. The spring tab of the insulating ring, which preferably lags behind the centering tab, can deflect elastically towards the centering tab due to its low stability compared to the centering tab when it penetrates into the joining opening of the contact adapter. This reliably compensates for manufacturing tolerances, in particular of the centering tab and/or the spring tab of the insulating ring and/or the joining opening of the contact adapter.

Please note that the definition of “A and/or B” is A alone, B alone or A and B.

Other features which are considered as characteristic for the invention are set forth in the appended claims.

Although the invention is illustrated and described herein as embodied in a stator for an electric motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a stator with a wound stator main body and with a contact adapter with insulation displacement contacts in plug-in pockets as well as with a joining opening and a pair of tabs (centering and spring tab) of an insulating ring accommodated therein;

FIG. 2 is a partial exploded view of the stator with the contact adapter above the insulating ring with a view of the joining opening on the adapter side and the pair of tabs on the insulating ring side formed of a centering tab and a spring tab;

FIG. 3 is a perspective view of the stator main body with the contact adapter mounted on the insulating ring;

FIGS. 4A and 4B are sectional views taken along line IV-IV shown in FIG. 3, the pair of tabs of the insulating ring as it enters the joining opening or as it is seated in the joining opening of the contact adapter; and

FIGS. 5A to 5D are schematic representations of the pair of tabs on the insulating ring side in an entry position of the centering tab into the joining opening on the adapter side, in a contact position of the centering tab at an opening edge of the joining opening, in a contact position of the spring tab at a further opening edge of the joining opening or in a situation in which the spring tab has sprung into the joining opening of the contact adapter.

Corresponding parts and dimensions are marked with the same reference signs in all figures.

### DETAILED DESCRIPTION OF THE INVENTION

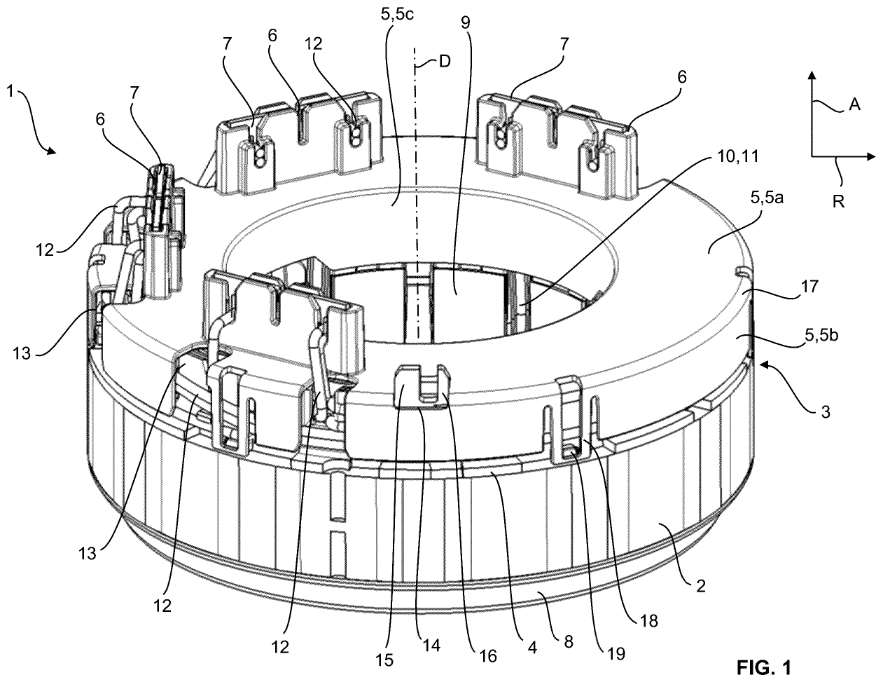

Referring now to the figures of the drawings in detail and first, particularly to FIG. 1 thereof, there is shown a stator 1, hereinafter also referred to as a stator assembly, which is provided for an electric motor, in particular as an electric drive for an assembly or an adjustment element of a motor vehicle. The stator or the stator assembly 1 has a stator body 2 and an insulating ring 4 arranged on one end face 3 of the stator body or mounted on the latter, as well as a contact adapter 5 mounted on the insulating ring 4 with a number of plug-in pockets 6 for contact elements 7 oriented in axial direction A in the example shown. A further insulating ring 8 is arranged on the opposite end face on the stator main body 2.

The indicated central axis D of the stator 1 is also the axis of rotation of a rotor, not shown, which is designed, for example, as a rotor laminated core with permanent magnets housed in it. In the electric motor designed as an internal rotor, the rotor is accommodated in the cylindrical space surrounded by the stator main body 2 and the contact adapter 5 as well as the insulating ring 4, forming a gap.

The stator main body 2 has a number of stator teeth 9 pointing inwards in the radial direction R towards the central axis D. Coils 10 of a stator or rotary field winding 11 are arranged on the stator teeth 9. The contact elements 7, designed as insulation displacement contacts, are provided and set up for connecting winding or coil ends 12 of the stator winding 11. It can be seen that individual winding ends 12 are guided along the outer circumference of the insulating ring 4 in the circumferential direction U of the stator main body 2 and led to the plug-in pockets 6 at corresponding points in the upper recesses 13 of the contact adapter 5 on its upper side in order to be contacted by means of the contact elements 7, preferably using insulation displacement technology. In turn, the contact elements 7 are used to (clampingly) contact three or, in the example shown, four phase connections of a matrix electronics for phase-selective energization of the stator winding 11, in a manner not shown in detail.

The contact adapter 5 has a joining opening 14, with which an axially oriented pair of tabs 15, 16 of the insulating ring 4 corresponds. The joining opening 14 runs in the circumferential direction U of the contact adapter 5 and is locally delimited. The joining opening 14 is arranged in the area of a transition edge 17 between an annular base plate 5a of the contact adapter 5 and a circumferential edge web 5b of the contact adapter 5, which edge web is attached to the base plate 5a. The edge web 5b and the base plate 5a, and preferably a further, radially inner edge web 5c, at least partially cover the insulating ring 4 on three sides in the axial direction A. The circumferential length of the joining opening 14 is, for example, 1/30 of the (circular) circumference of the contact adapter 5.

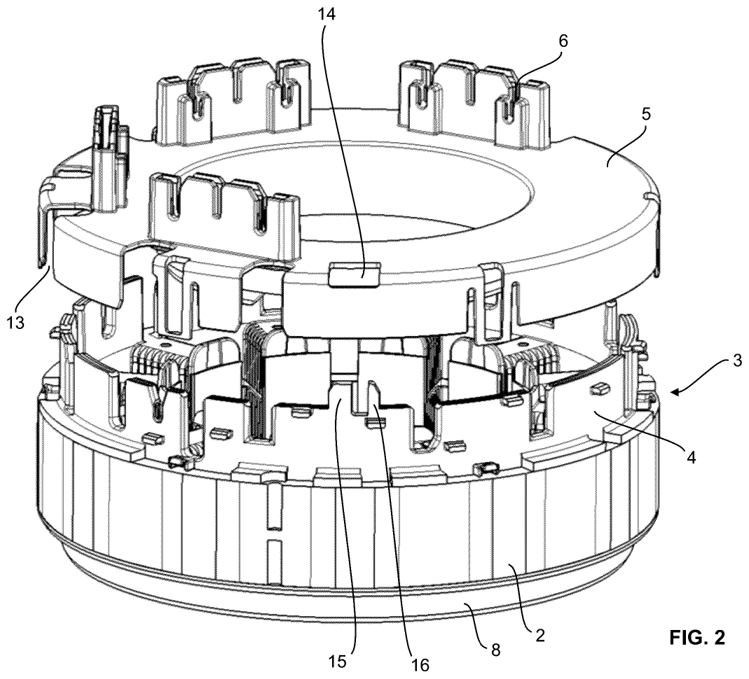

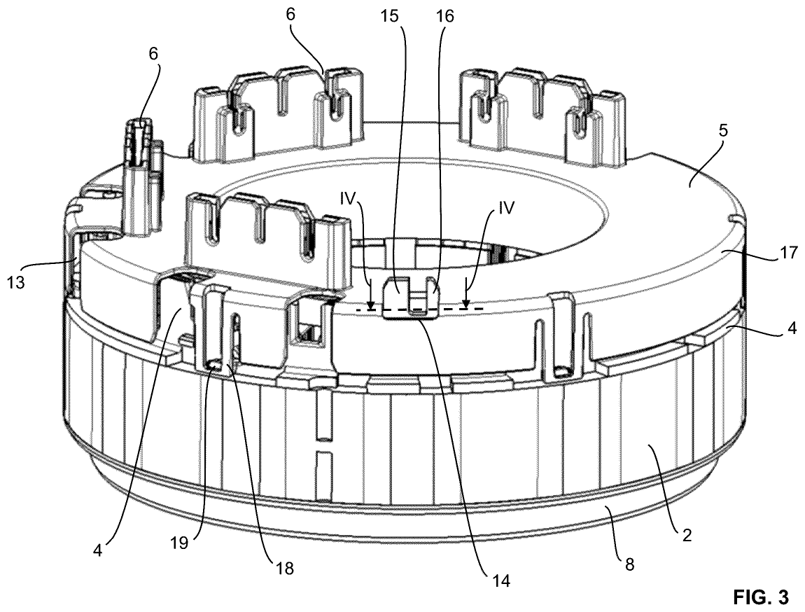

As can be seen in conjunction with FIGS. 2 and 3, the contact adapter 5 has a number of axially extending joining tabs 18 spaced apart in the circumferential direction U. In the course of placing or pressing the contact adapter 5 onto the insulating ring 4, these latches engage with corresponding joining elements or latching elements 19 of the insulating ring 4 to produce a joint connection, for example a detachable joint connection.

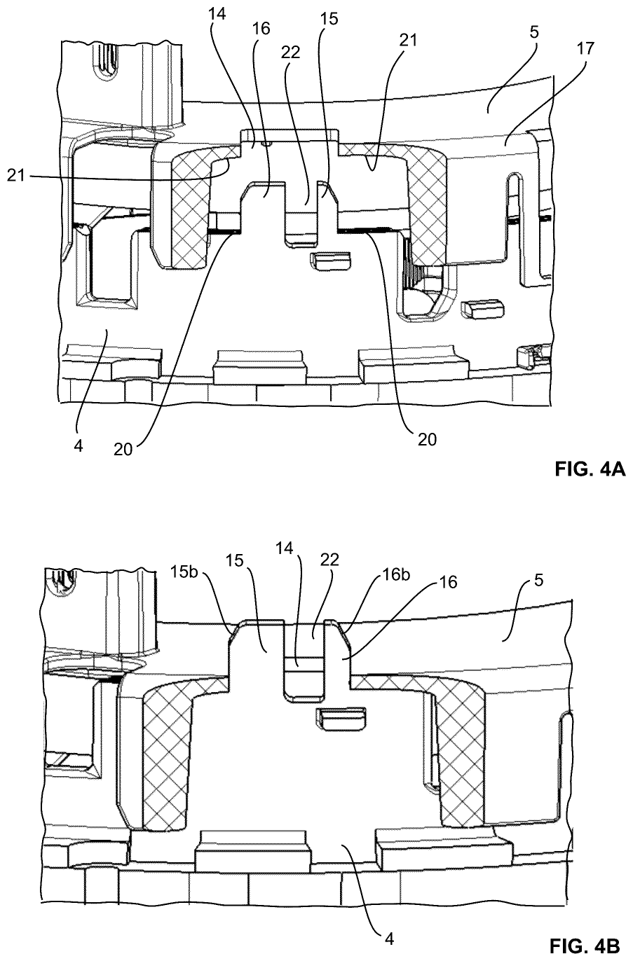

FIGS. 4A and 4B show a partial section of the joining opening 14 of the contact adapter 5 showing the pair of tabs 15, 16 entering the joining opening 14 of the contact adapter 5 from the lower or rear side of its ring-shaped base plate 5a or in the end position. In this position, lateral shoulder portions 20 of the pair of tabs 15, 16 rest against the opening edges of the plate portions 21 of the contact adapter 5 flanking the narrow sides of the joining opening 14.

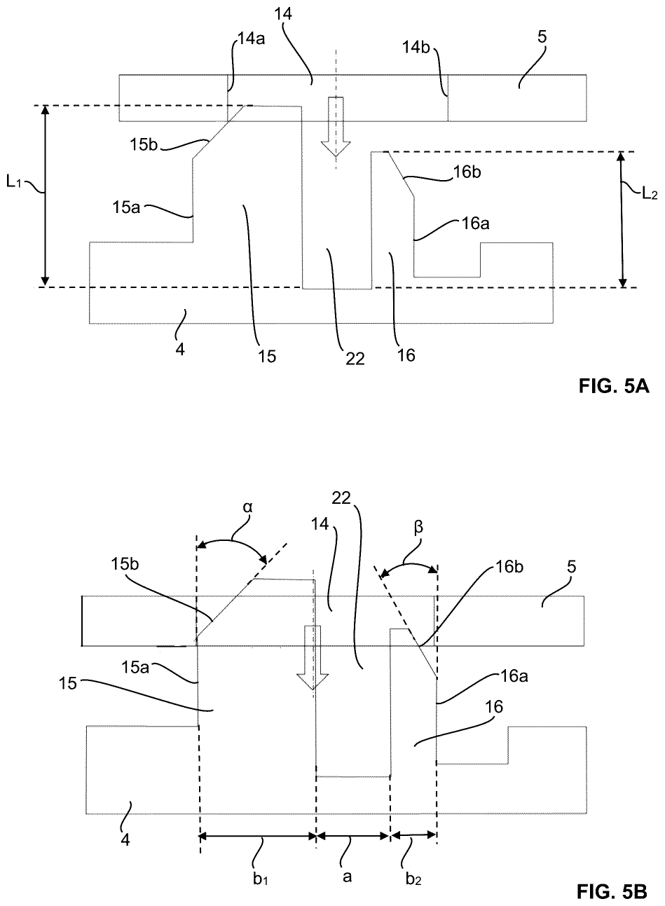

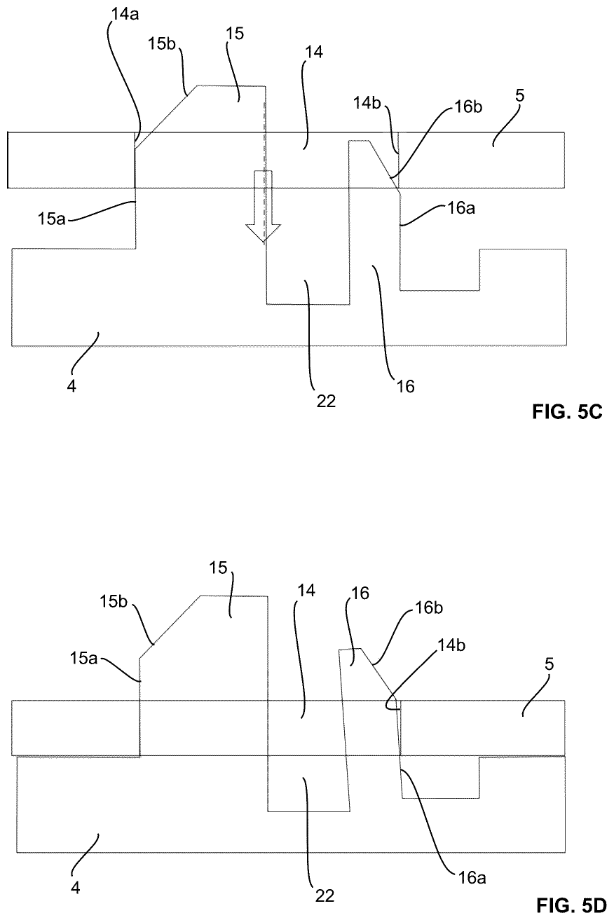

The insulating ring 4 has an axial centering tab 15, also referred to below as a centering pin, and an axial spring tab 16 parallel to it, also referred to below as a spring pin. These form the pair of tabs 15, 16. More than one, for example two, centering tabs 15 and/or more than one, for example two, spring tabs 16 can also be provided. In the joined state of the contact adapter 5 with the insulating ring 4, the spring tab 16 engages through the joining opening 14 of the contact adapter 5 together with the centering tab 15 or lagging behind it (FIG. 5B). The centering tab 15 aligns the contact adapter 5 in its target position.

On the one hand, the spring tab 16 serves to compensate for (manufacturing) tolerances. In addition, the spring tab 16 removes any existing mechanical play from the (mechanical) interface between the contact adapter 5 and the insulating ring 4. For this purpose, the spring tab 16 can spring or deflect into a free space 22. The free space 22 is provided due to the (azimuthal) distance in circumferential direction U between the centering tab 15 and the spring tab 16, which runs parallel to it in the axial direction A.

FIGS. 5A to 5D schematically show the (mechanical) interface between the insulating ring 4 and the contact adapter 5 in the area of the joining opening 14 and the corresponding pair of tabs 15, 16.

The centering tab 15 of the insulating ring 4 has an axially extending positioning edge 15a and an inlet edge 15b that adjoins it in the axial direction A and is inclined or set in the direction of the spring tab 16. The angle of inclination α shown in relation to the axial extent of the positioning edge 15a is approximately 45°.

As illustrated in FIG. 5A, when the contact adapter 5 is placed on the insulating ring 4, an opening edge 14a of the joining opening 14 touches the corresponding inlet edge 15b of the centering tab 15 and slides along the inlet edge 15b of the centering tab 15 when the contact adapter 5 is further placed or pressed onto the insulating ring 4 in the direction of the arrow shown. The joining opening 14 and thus the contact adapter 5 aligns itself on the centering tab 15 in the direction of the target position of the contact adapter 5 relative to the insulating ring 4 and thus relative to the stator main body 2. As can be seen from FIG. 5B, the contact adapter 5 is subsequently aligned at the positioning edge 15a of the centering tab 15 during further pressing onto the insulating ring 4, which is suitably tolerated as precisely as possible at or on the insulating ring 4.

FIGS. 5C and 5D also show that the spring tab 16 of the insulating ring 4 has an axially extending joining edge 16a and a sliding edge 16b that adjoins it in the axial direction A and is inclined at an angle of attack β to the centering tab 15. The angle of attack β relative to the axial extent of the joining edge 16a is approximately 60°. In the exemplary embodiment, the axial tab length L₂ of the spring tab 16 is smaller than the axial tab length L₁ of the centering tab 15.

As illustrated in FIGS. 5C and 5D, the spring tab 16 with its sliding edge 16b initially slides along a corresponding opening edge 14b of the joining opening 14 when the contact adapter 5 is pressed onto the insulating ring 4. If tolerances need to be compensated for or if play needs to be eliminated at the mechanical interface, the spring tab 16 springs into the free space 22 between the spring tab and the centering tab 15. The distance or clear width a between the centering tab 15 and the spring tab 16 of the insulating ring 4 forming the free space 22 is smaller than the tab width b₁ of the centering tab 15.

In the exemplary embodiment, this distance a between the centering tab 15 and the spring tab 16 of the insulating ring 4 is greater than the tab width b₂ of the spring tab 16. The tab width b₁ of the centering tab 15, viewed in the circumferential direction U of the insulating ring 4, is in particular greater by a factor of two (2) to three (3) than the tab width b₂ of the spring tab 16. The centering tab 15 is therefore more stable than the spring tab 16, which is also sufficiently resilient to be able to move out of the way when the contact adapter 5 joins the insulating ring 4, in particular into the free space 22.

In summary, the invention relates to a stator or a stator assembly 1 for an electric motor, having a stator main body 2 with stator teeth 9 and a stator winding 11 arranged thereon, an insulating ring 4 arranged on an end face of the stator main body 2, and a contact adapter 5 with a joining opening 14 which can be placed or pressed onto it, wherein the insulating ring 4 has a pair of tabs 15, 16 which correspond to the joining opening 14 and are received in the joining opening 14 of the contact adapter 5 when the contact adapter 5 is placed onto the insulating ring 4, or engages through the joining opening 14 when the contact adapter 5 is in the joined state. A centering tab 15 of the insulating ring 4 centers the contact adapter 5 in its target position, while the centering tab 15 on the insulating ring side penetrates into the joining opening 16 on the contact adapter side.

The spring tab 16 of the insulating ring 4, which preferably lags behind the centering tab 15, can spring in towards the centering tab 15 due to its low stability compared to the centering tab 15 when penetrating the joining opening 14 of the contact adapter 5, in order to reliably compensate for manufacturing tolerances, in particular of the centering tab 15 and/or the spring tab 16 of the insulating ring 4 and/or the joining opening 14 of the contact adapter 5.

The invention is not limited to the exemplary embodiment described above. Rather, other variants of the invention can also be derived from it by a person skilled in the art without departing from the subject matter of the invention. In particular, all the individual features described in conjunction with the exemplary embodiment can also be combined with one another in other ways without departing from the subject matter of the invention.

The following is a summary list of reference numerals and the corresponding structure used in the above description of the invention:
1 stator/assembly
2 stator main body
3 end face
4 insulating ring
5 contact adapter
5a base plate
5b, 5c edge web
6 plug-in pockets
7 contact element/insulation displacement contact
8 insulating ring
9 stator tooth
10 coil
11 stator/rotary field winding
12 winding/coil end
13 recess
14 joining opening
14a, 14b opening edge
15 centering tab
15a positioning edge
15b inlet edge
16 spring tab
16a joining edge
16b sliding edge
17 transition edge
18 joining tab
19 joining/latching element
20 shoulder portion
21 plate portions/opening edge
22 free space
A axial direction
D (rotary) axis
L_{1,2} tab length
R radial direction
U circumferential direction
A distance/clear width
b_{1,2} tab width
α angle of inclination
β angle of attack

1. A stator for an electric motor, comprising:
a stator main body with stator teeth directed radially inwards towards a central axis with a stator winding disposed on said stator teeth and having winding ends;
an insulating ring disposed on an end face of said stator main body;
a contact adapter, mounted on said insulating ring, and having a plurality of axially oriented plug-in pockets for contact elements for connection contacting of said winding ends of said stator winding, wherein said contact adapter has a tangentially or azimuthally extending joining opening; and
said insulating ring having at least one axial centering tab corresponding to said joining opening of said contact adapter and an axial spring tab parallel to said at least one axial centering tab, said axial spring tab in a joined state with said contact adapter is received together with said at least one axial centering tab in said joining opening of said contact adapter.

2. The stator according to claim 1, wherein said joining opening is disposed in a region of a transition edge between an annular base plate of said contact adapter and an axial or axially extending edge web, which is integrally molded on said annular base plate, and which at least partially covers a circumference of said insulating ring.

3. The stator according to claim 1, wherein:
said insulating ring has joining elements; and
said contact adapter has a plurality of axially extending joining tabs which, in the joined state, latch with said joining elements of said insulating ring.

4. The stator according to claim 1, wherein between said at least one axial centering tab and said axial spring tab of said insulating ring there is formed a free space into which said axial spring tab springs when it is inserted into said joining opening of said contact adapter.

5. The stator according to claim 1, wherein said at least one axial centering tab of said insulating ring has an axially extending positioning edge and an inlet edge adjoining it in an axial direction and set at an angle of inclination to said axial spring tab.

6. The stator according to claim 5, wherein the angle of inclination relative to the axially extending positioning edge is between 30° and 60°.

7. The stator according to claim 1, wherein said axial spring tab of said insulating ring has an axially extending joining edge and a sliding edge adjoining said axially extending joining edge in an axial direction and inclined at an angle of incidence to said at least one axial centering tab.

8. The stator according to claim 7, wherein the angle of incidence relative to the axially extending joining edge is between 50° and 70°.

9. The stator according to claim 1, wherein:
a tab width of said at least one axial centering tab in a circumferential direction of said insulating ring is greater than a tab width of said axial spring tab; and/or
said at least one axial centering tab of said insulating ring, when it penetrates into said joining opening of said contact adapter, guides it into its target position and said axial spring tab of said insulating ring springs in towards said at least one axial centering tab when it penetrates said joining opening of said contact adapter, in order to compensate for manufacturing tolerances.

10. The stator according to claim 1, wherein:
a distance between said at least one axial centering tab and said axial spring tab of said insulating ring is smaller than a tab width of said at least one axial centering tab; and/or
a distance between said at least one axial centering tab and said axial spring tab of said insulating ring is greater than or equal to a tab width of said axial spring tab; and/or
an axial tab length of said at least one axial centering tab is at least slightly greater than an axial tab length of said axial spring tab of said insulating ring.

11. The stator according to claim 1, wherein said contact elements are insulation displacement contacts.

12. The stator according to claim 3, wherein said joining elements of said insulating ring are radially oriented joining elements.

13. The stator according to claim 6, wherein the angle of inclination relative to said axially extending positioning edge is 45°±5°.

14. The stator according to claim 8, wherein the angle of incidence relative to said axially extending joining edge is 60°±5°.

15. The stator according to claim 1, wherein:
a tab width of said at least one axial centering tab in a circumferential direction of said insulating ring is greater than a tab width of said axial spring tab; and/or
said at least one axial centering tab of said insulating ring, when it penetrates into said joining opening of said contact adapter, guides it into its target position and said axial spring tab of said insulating ring, which lags behind said at least one axial centering tab, springs in towards said at least one axial centering tab when it penetrates said joining opening of said contact adapter, in order to compensate for manufacturing tolerances in at least one of said at least one axial centering tab, said axial spring tab of said insulating ring, or of said joining opening of said contact adapter.

16. The stator according to claim 9, wherein said tab width of said at least one axial centering tab in the circumferential direction of said insulating ring is greater, by a factor of 2 to 3, than the tab width of said axial spring tab.

17. An electric motor, comprising:
said stator according to claim 1.
